(19) United States
(12) Patent Application Publication
(10) Pub. No.: US 2008/0279993 A1
(43) Pub. Date: Nov. 13, 2008

(54) Security stick

(76) Inventor: Normand Roy, Saint-Paul (CA)

Correspondence Address: NORMAND ROY, 15 DAGENAIS, ST. PAUL, QC, JOK 3E0, CA

(21) Appl. No.: 12/011,670

(22) Filed: Jan. 30, 2008

(30) Foreign Application Priority Data
May 11, 2007 (CA) CA 2541352

(51) Int. Cl. A23G 3/56

(52) U.S. Cl. 426/134

(57) ABSTRACT

The security stick is made with an extended curve of 90°. At one of the extremities is the candy and the continuity of the stick curves in a 90° extended direction. It is this curve which makes it safe if contact occurs. The <90° extended> turns gradually in the new direction and creates a curve which will render the new lollypop completely safe for the user. The length of the stick doesn't alter its safety, when the stick is curved in a 90° extended angle, it becomes the security stick.

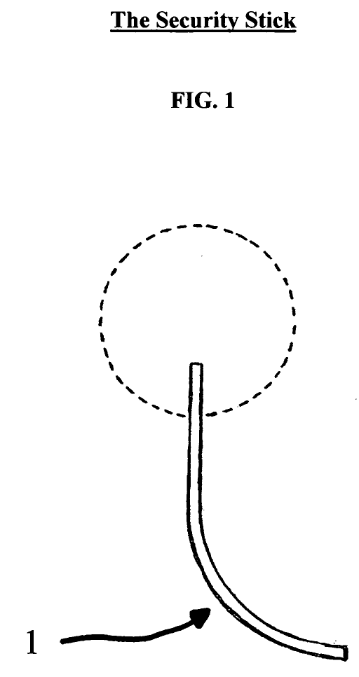

A stick that holds a candy commonly known as a lollypop, the stick is formed so that it is safe for the user. It's unique shape is made to ensure that if there is contact, the stick won't go to the back of the throat of the user. The shape of the stick does not alter it's use and easy manipulation. Nothing is added to the stick, it's unique shape will give it it's own identity.

### DESCRIPTION

The continuity of the stick which holds the candy, turns to a 90° angle extension. The curve that brings this 90° angle, ensures that upon contact, the stick will go to the side of the cheek of the user. The stick will have a unique shape that will ensure its safety. The stick shaped as 90° extended has its own characteristics, will have its own identity, it will be identified by its safety aspect and by its shape. It brings a measure of security for the user.

1. I request that the security lollypop be recognized as a distinct stick with its own unique characteristics. The traditional lollypop is dangerous for the user. When there is a fall or contact, it can be forced to the back of the throat of the user and cause serious injuries and even choke the user. The security stick is created to render it safe for the user. If there is a fall or contact the security stick will go to the side of the cheek of the user. Its distinct shape will identify it as safe. The shape of the stick doesn't change its utility and easy manipulation. Most of the consumers of lollypops are children and I believe that giving a child a lollypop with a traditional stick is dangerous. The security stick is an innovative concept that will make the world of lollypops safer, especially for our children.
